(19) United States
(12) Patent Application Publication
(10) Pub. No.: US 2022/0170591 A1
(43) Pub. Date: Jun. 2, 2022

(54) DRIVESHAFT CONTAINMENT APPARATUS

(71) Applicant: Gilles Marc Dube, County of Grande Prairie No. 1 (CA)

(72) Inventor: Gilles Marc Dube, County of Grande Prairie No. 1 (CA)

(21) Appl. No.: 17/108,387

(22) Filed: Dec. 1, 2020

(51) Int. Cl. F16P 1/02; B60K 17/24

(52) U.S. Cl. CPC F16P 1/02; B60K 17/24

(57) ABSTRACT

A driveshaft containment apparatus is provided. A driveshaft containment apparatus for restricting mobility of a driveshaft during a ruptured driveshaft event, comprising a primary plate comprising a plurality of fastener holes for securing the primary plate to a secondary plate and securing the primary plate to a crossmember of a vehicle. The secondary plate comprising a plurality of fastener holes for securing the secondary plate to the primary plate and the primary plate coupled to the secondary plate such that the driveshaft is encompassed and confined by the primary plate and the secondary plate coupling.

### FIELD OF THE INVENTION

The present disclosure relates to a driveshaft containment apparatus more specifically, but not by way of limitation, more particularly to a bracket which encompasses a driveshaft for restricting mobility of the driveshaft during a ruptured driveshaft event.

### BACKGROUND

Driveshaft failure can result in catastrophic damage to the vehicle and under some circumstances severe injury or death to the occupants. Driveshaft failure can cause major damage to transmission, transfer case, wiring harness, fuel lines, front differential, and rip the floor out of the truck cab and in some circumstances resulting in damages in excess of $20,000.00. Typically, during failure the transmission and transfer case will result in holes punched through the side from the flailing driveshaft, the wiring harness and fuel lines may also be ripped out, the front differential can get cracked or bent, and the cab floor may have holes punched right through or has been ripped away under drivers feet. Current systems and methods for addressing driveshaft failure consist of one or more of the following shortcomings: insufficient confinement of the driveshaft in all directions, invasive and arduous installation onto the vehicle, and bulkiness and excessive component composition increasing materials costs, maintenance and repair.

WO Pub. No. 2004/078551 A1 (Coppens) discloses a containment bracket for a drive shaft. Shortcomings include the invasive and arduous installation of the containment bracket system surrounding the driveshaft and onto the frame, and the maintenance and repair for components such as the tension cable.

U.S. Pat. No. D601,587 S (Beatty) discloses an ornamental design for a driveshaft tunnel. Shortcomings include the invasive arduous installation of the driveshaft tunnel onto the driveshaft and frame and inability for the carrier bearing assembly to sufficiently secure in place and in all directions during the event of a rapture drive shaft.

U.S. Pat. No. 9,956,872 B2 (Roberts et al.) discloses a carrier bearing assembly. Shortcomings include an inability for the carrier bearing assembly to sufficiently secure the drive shaft in place in all directions during the event of a rapture drive shaft.

U.S. Pat. No. 8,998,730 B2 (Pittman) discloses a driveshaft containment system. Shortcomings include the need to couple the system with the driveshaft, the invasive and arduous installation of the driveshaft containment system to the driveshaft and onto the frame and the maintenance and repair for various components of the driveshaft containment system.

U.S. Pat. No. 8,857,060 B2 (Singh et al.) discloses a center section for a crossmember comprising a driveshaft hoop. Shortcomings include the invasive and arduous installation of the driveshaft containment system to the driveshaft and onto the frame, increased costs for materials and installation and the maintenance and repair for various components of the center section for a crossmember.

U.S. Pat. No. 5,906,347 A (Noland) discloses a center section for a crossmember comprising a driveshaft hoop. Shortcomings include the lack of integrity of the main body portion due to the distance between the mounting flange and drive shaft containment device.

U.S. Pat. No. 5,711,710 A (Brisk) discloses a rotating shaft coupling guard for a drive-train structure for applications such as pumps and turbines. Shortcomings include the bulkiness of the system and inability to apply this system to a front driveshaft of a vehicle as presented.

U.S. Pat. No. 4,696,660 A (Murphy et al.) discloses a tractor drive shaft shield assembly. Shortcomings include the bulkiness of the system and inability to apply this system to a front driveshaft of a vehicle as presented.

U.S. Pat. No. 2,984,090 A (Bennett) discloses a shield for a drive shaft. Shortcomings include the bulkiness of the system, the invasive and arduous installation of the driveshaft containment system to the driveshaft and onto the frame, increased costs for materials and the maintenance and repair for various components of the vehicle.

I.E. Pub. No. 2014/0149 A1 (Kavanagh) discloses a vehicle driveshaft safety device. Shortcomings include an inability for the vehicle driveshaft safety device to sufficiently secure the driveshaft in place in all directions during the event of a rapture drive shaft.

All documents cited herein are incorporated by reference.

There is a need for a driveshaft containment apparatus that sufficiently secures the driveshaft in place in all directions during the event of a rapture driveshaft, that allows for noninvasive and straightforward installation of the containment apparatus onto the vehicle while fully encompassing the driveshaft, is compact and comprises few components for minimal materials costs, maintenance and repair.

### BRIEF SUMMARY

To be continued.

It is the object of the present invention to provide a driveshaft containment apparatus. A driveshaft containment apparatus for restricting mobility of a driveshaft during a ruptured driveshaft event, comprising a primary plate comprising a plurality of fastener holes for securing the primary plate to a secondary plate and securing the primary plate to a crossmember of a vehicle. The secondary plate comprising a plurality of fastener holes for securing the secondary plate to the primary plate and the primary plate coupled to the secondary plate such that the driveshaft is encompassed and confined by the primary plate and the secondary plate coupling.

In accordance with an aspect of the invention, there is provided a method of retrofitting the driveshaft containment apparatus onto the vehicle, comprising inserting the primary plate against the crossmember such that the driveshaft is partially confined by the primary plate. Inserting the secondary plate against the primary plate such that the primary plate and the secondary plate encompass and confine the driveshaft and applying a plurality of fasteners to the primary plate, the secondary plate and the crossmember such that the primary plate is securely affixed to the crossmember and the secondary plate is securely affixed to the primary plate.

In accordance with an aspect of the invention, there is provided a driveshaft containment apparatus assembly kit, for restricting mobility of a driveshaft during a ruptured driveshaft event, the kit comprising a primary plate comprising a plurality of fastener holes for securing the primary plate to a secondary plate and securing the primary plate to a crossmember of a vehicle. The secondary plate comprising a plurality of fastener holes for securing the secondary plate to the primary plate and a plurality of fasteners.

In accordance with an embodiment of the invention, the primary plate and the secondary plate couple to form a circular opening.

In accordance with an embodiment of the invention, the secondary plate is horseshoe shaped.

In accordance with an embodiment of the invention, the driveshaft containment apparatus further comprises a stiffener plate.

In accordance with an embodiment of the invention, the stiffener plate is manufactured onto the primary plate.

In accordance with an embodiment of the invention, driveshaft containment apparatus is manufactured into the vehicle.

In accordance with an embodiment of the invention, the kit further comprises instructions for installation.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an aspect of the subject matter in accordance with one embodiment.

FIG. 2 illustrates an aspect of the subject matter in accordance with one embodiment.

FIG. 3 illustrates an aspect of the subject matter in accordance with one embodiment.

FIG. 4 illustrates an aspect of the subject matter in accordance with one embodiment.

FIG. 5 illustrates an aspect of the subject matter in accordance with one embodiment.

FIG. 6 illustrates an aspect of the subject matter in accordance with one embodiment.

FIG. 7 illustrates an aspect of the subject matter in accordance with one embodiment.

FIG. 8 illustrates an aspect of the subject matter in accordance with one embodiment.

FIG. 9 illustrates an aspect of the subject matter in accordance with one embodiment.

FIG. 10 illustrates an aspect of the subject matter in accordance with one embodiment.

### DETAILED DESCRIPTION

The details of one or more embodiments of the subject matter of this specification are set forth in the accompanying drawings and the description below. Other features, aspects, and advantages of the subject matter will become apparent from the description, the drawings, and the claims.

Like reference numbers and designations in the various drawings indicate like elements.

There are many complaints about the immense damage that may result from a driveshaft failure, especially in 4-wheel vehicles such as ¾ ton, 1 ton, and 5500 4-wheel drive trucks. A broken driveshaft can break brake lines, fuels lines, wiring harness, rupture the frame, transfer case, transmission housing, front differential, can result in serious injury or even death. The driveshaft containment apparatus, presented hereafter, is employed to restrict mobility of a driveshaft during a ruptured driveshaft event. The driveshaft containment apparatus acts to encompass and confine the inner components of the driveshaft during failure to avoid these components from flailing around and damaging other components of the vehicle.

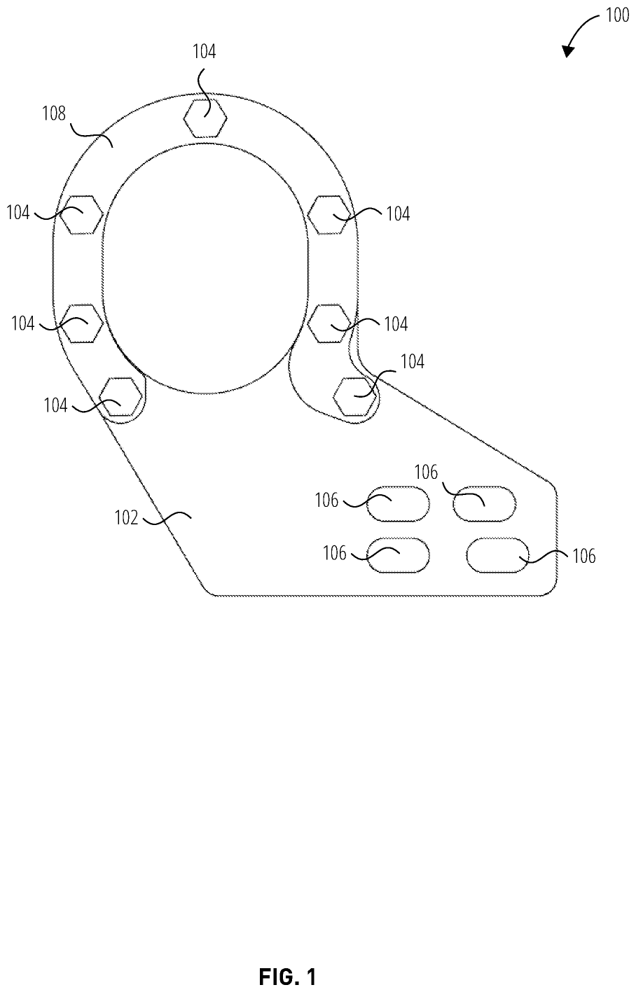

FIG. 1 depicts a front view 100 of the driveshaft containment apparatus as in one embodiment. The driveshaft containment apparatus comprises a primary plate 102 and a secondary plate 108, as shown in FIG. 1. The primary plate 102 comprises a plurality of fastener holes 106 for securing the primary plate 102 to the secondary plate 108 plate and securing the primary plate 102 to a crossmember of a vehicle.

Likewise, the secondary plate 108 comprises a plurality of fastener holes 106 for securing the secondary plate 108 to the primary plate 102. A plurality of fasteners 104 are shown securing the secondary plate 108 to the primary plate 102, coupling the primary plate 102 to the secondary plate 108 such that the driveshaft is encompassed and confined by the primary plate 102 and the secondary plate 108 coupling.

Fasteners 104 employed for securing the primary plate 102, secondary plate 108 and crossmember may include bolts or any other fasteners known in the art. In some embodiments, the bolts from the crossmember may be used. In some embodiments, the primary plate 102 and the secondary plate 108 couple to form a circular opening. In some embodiments, the driveshaft containment apparatus is manufactured into a vehicle.

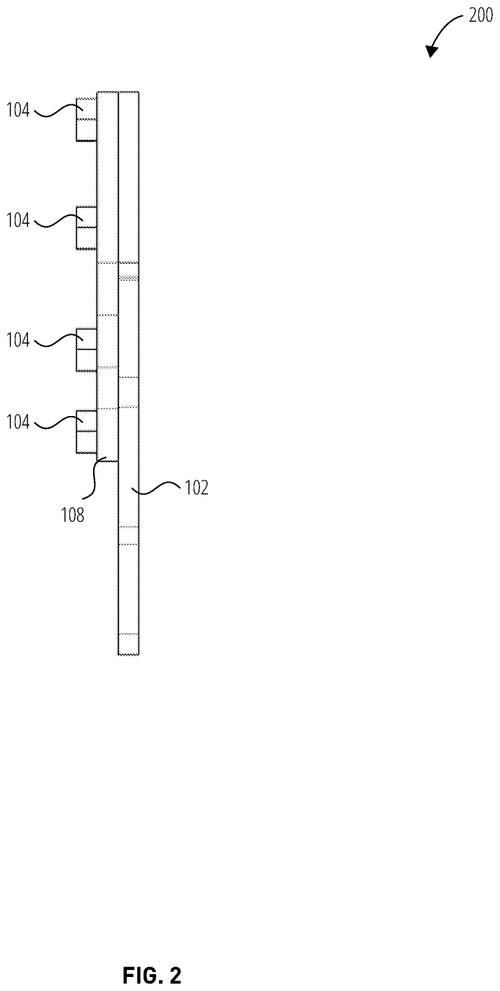

FIG. 2 depicts a side view 200 of the driveshaft containment apparatus as in one embodiment, where the fasteners 108 are shown securing the primary plate 102 against the secondary plate 108.

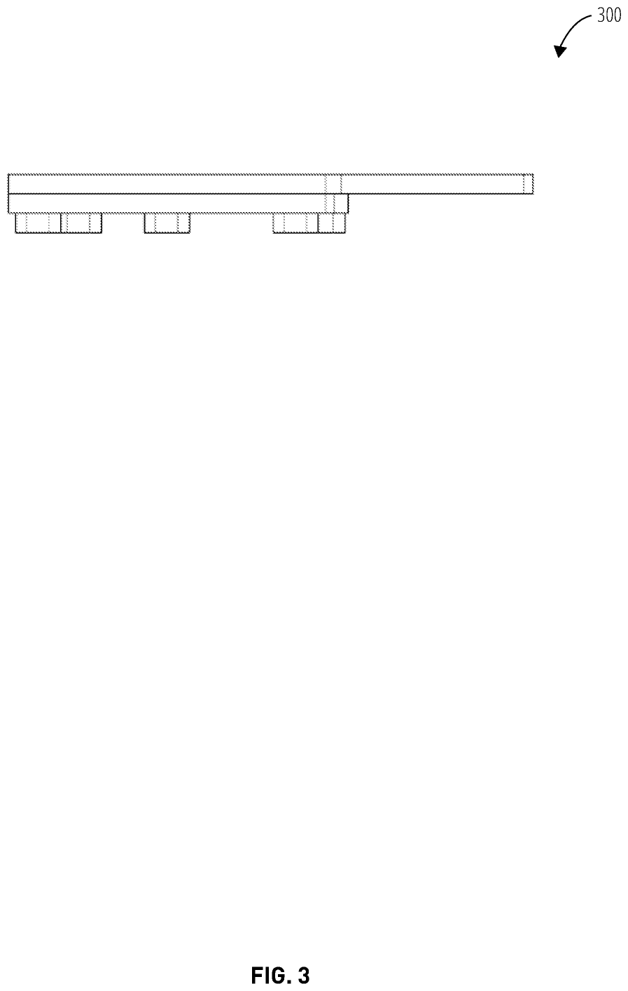

FIG. 3 depicts a top view 300 of the driveshaft containment apparatus as in one embodiment.

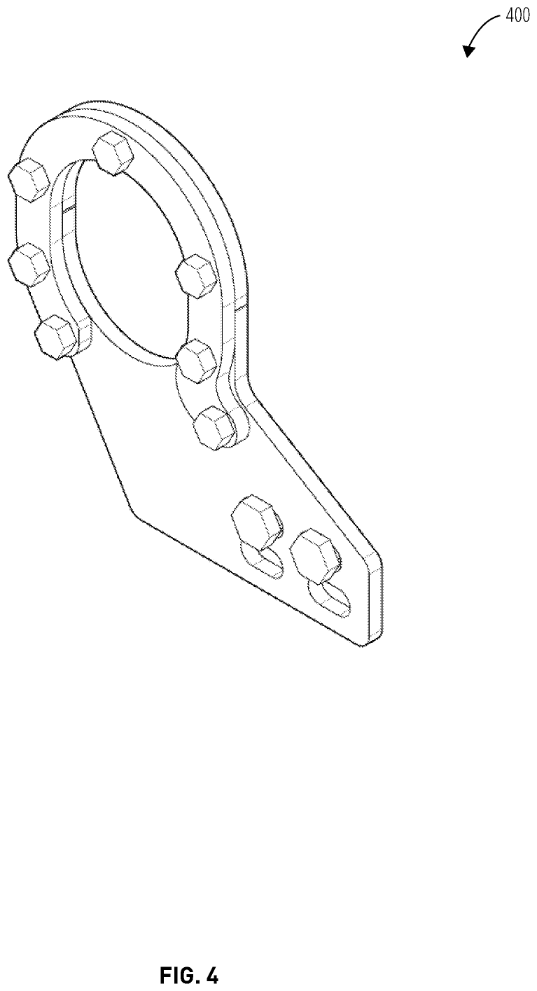

FIG. 4 depicts a perspective view 400 of the driveshaft containment apparatus as in one embodiment.

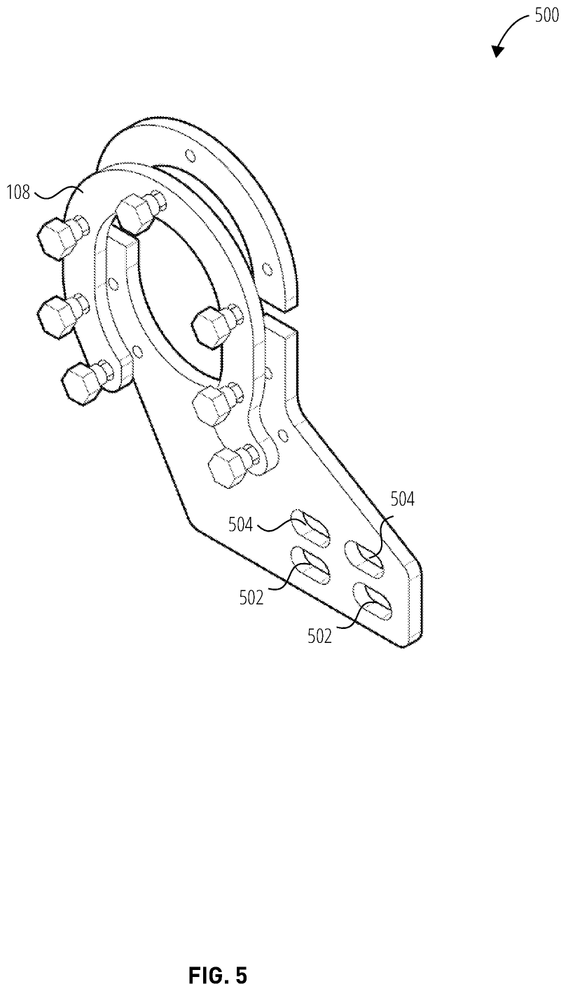

FIG. 5 depicts an exploded view 500 of the driveshaft containment apparatus as in one embodiment. This embodiment displays two sets of fastener holes 106, upper slots 504 and lower slots 502. The top upper slots 504 may be employed for securing the driveshaft containment apparatus to stock vehicles such as, but not limited to, a 2500 or 3500 Dodge Ram. The lower slots 502 may be employed for securing the driveshaft containment apparatus to lifted or modified vehicles as the driveshaft may be angled in these types of vehicles. In some embodiments, the secondary plate 108 is horseshoe shaped, such as in FIG. 5.

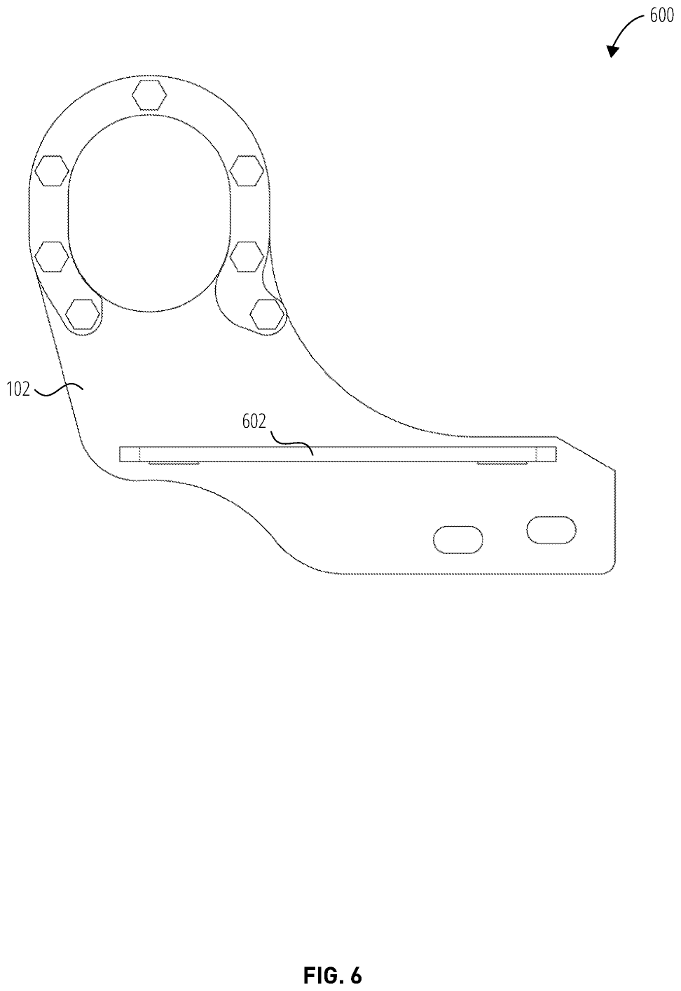

FIG. 6 depicts a front view 600 of the driveshaft containment apparatus as in one embodiment. This embodiment displays a driveshaft containment apparatus further comprising a stiffener plate 602. In some embodiments, the stiffener plate 602 is manufactured onto the primary plate 102. The addition of A stiffener plate 602 may be employed on vehicles such as, but not limited to, 1500, 2500, 3500, 4500, and 5500 Dodge trucks, 1500, 2500, 3500, 4500, and 5500 Ford trucks, and 1500, 2500, 3500, 4500, and 5500 Chevy trucks, to prevent the plates from bending or deformations, while adding additional rigidity to the device.

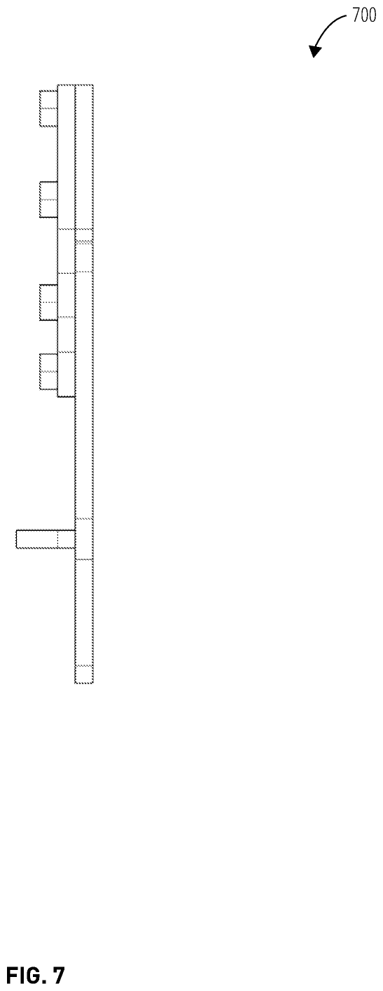

FIG. 7 depicts a side view 700 of the driveshaft containment apparatus as in one embodiment.

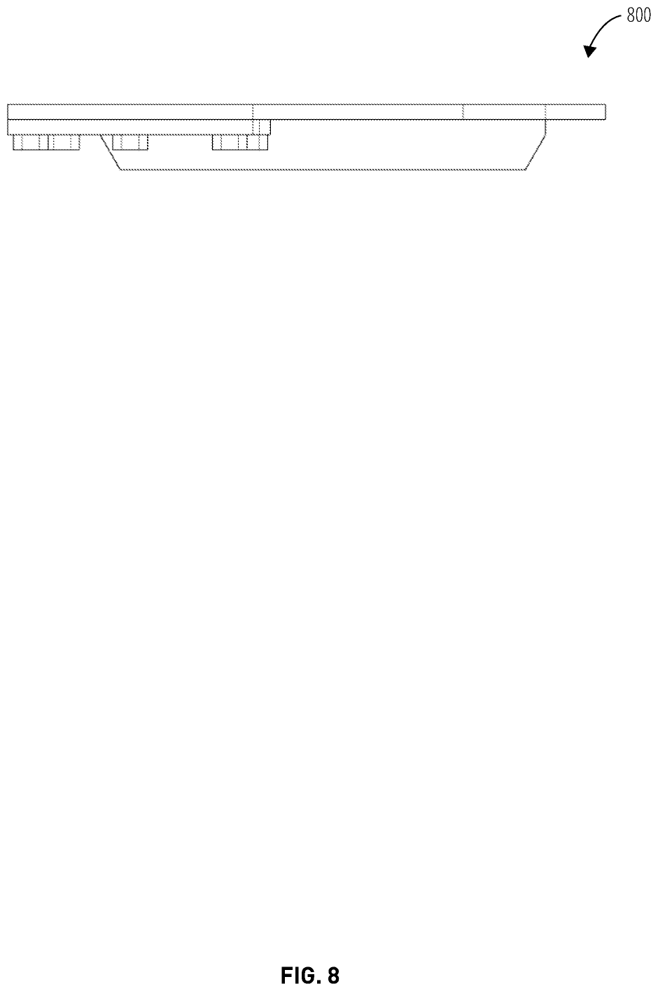

FIG. 8 depicts a top view 800 of the driveshaft containment apparatus as in one embodiment.

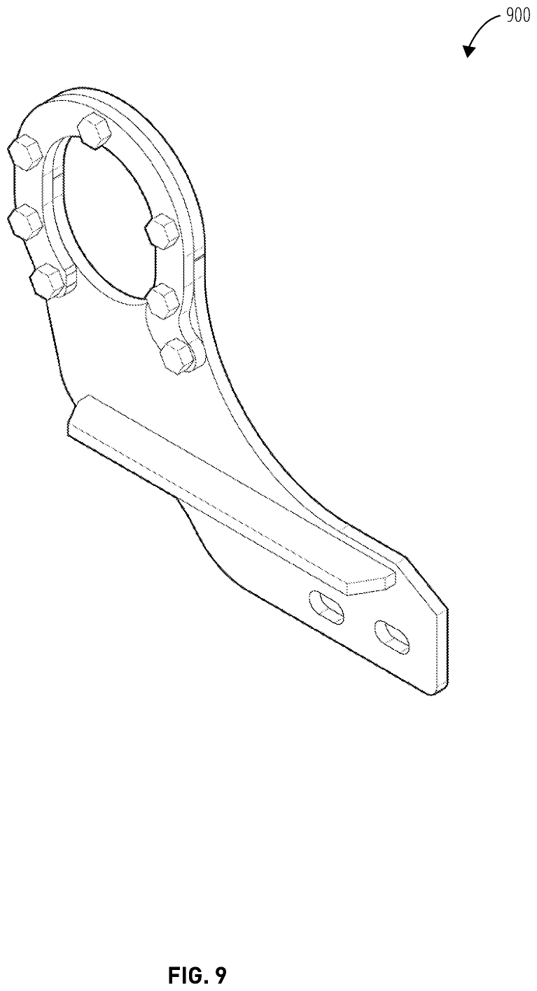

FIG. 9 depicts a perspective view 900 of the driveshaft containment apparatus as in one embodiment.

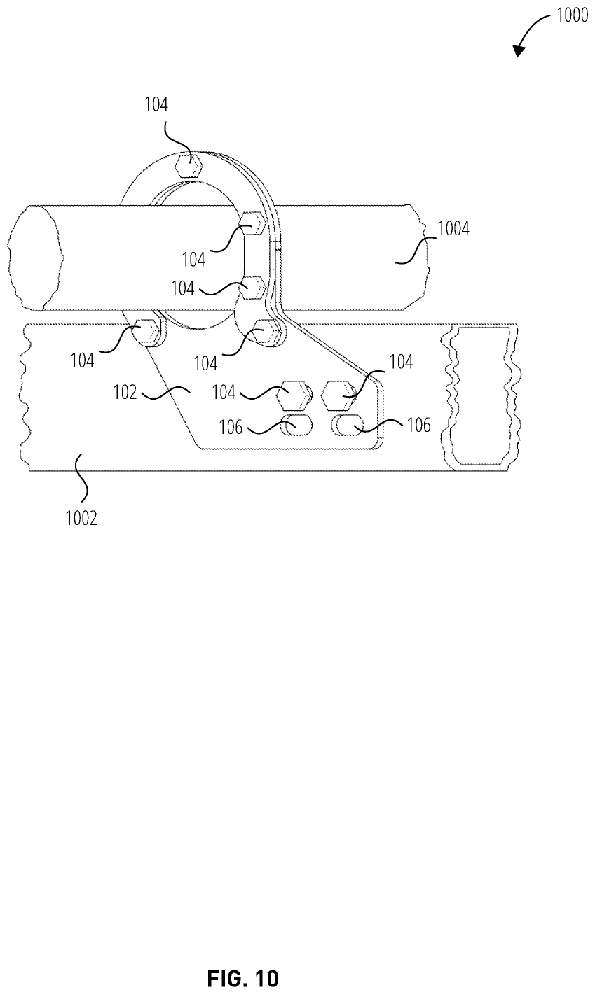

FIG. 10 depicts an applied view 1000 of the driveshaft containment apparatus as in one embodiment. A method for retrofitting the driveshaft containment apparatus onto a vehicle comprises inserting the primary plate 102 against a crossmember 1002 such that the driveshaft 1004 is partially confined by the primary plate 102, inserting the secondary plate 108 against the primary plate 102 such that the primary plate 102 and the secondary plate 108 encompass and confine the driveshaft 1004, and applying a plurality of fasteners 104 to the primary plate 102, the secondary plate 108 and the crossmember 1002 such that the primary plate 102 is securely affixed to the crossmember 1002 and the secondary plate 108 is securely affixed to the primary plate 102. In some embodiments, the driveshaft containment apparatus is assembled to the driveshaft 1004 such that the driveshaft containment apparatus encases the driveshaft 1004 3 inches from the rear yolk, as this is typically where the driveshaft 1004 ruptures in such an event.

In some embodiments, a driveshaft containment apparatus assembly kit comprises a primary plate 102 comprising a plurality of fastener holes 106 for securing the primary plate 102 to a secondary plate 108 and securing the primary plate 102 to a crossmember 1002 of a vehicle, the secondary plate 108 comprising a plurality of fastener holes 106 for securing the secondary plate 108 to the primary plate 102 and a plurality of fasteners 104. In some embodiments, the primary plate 102 and the secondary plate 108 couple to form a circular opening. In some embodiments, the secondary plate 108 is horseshoe shaped. In some embodiments, the kit further comprises a stiffener plate 602. In some embodiments, the stiffener plate 602 is manufactured onto the primary plate 102. In some embodiments, the kit further comprises instructions for installation.

The foregoing descriptions of specific embodiments of the present invention have been presented for purposes of illustration and description. They are not intended to be exhaustive or to limit the invention and method of use to the precise forms disclosed. Obviously, many modifications and variations are possible in light of the above teaching. The embodiments described were chosen and described in order to best explain the principles of the invention and its practical application, and to thereby enable others skilled in the art to best utilize the invention and various embodiments with various modifications as are suited to the particular use contemplated. It is understood that various omissions or substitutions of equivalents are contemplated as circumstance may suggest or render expedient but is intended to cover the application or implementation without departing from the spirit or scope of the claims of the present invention.

What is claimed is:

1. A driveshaft containment apparatus for restricting mobility of a driveshaft during a ruptured driveshaft event, comprising:
a primary plate comprising a plurality of fastener holes for securing said primary plate to a secondary plate and securing said primary plate to a crossmember of a vehicle;
said secondary plate comprising a plurality of fastener holes for securing said secondary plate to said primary plate; and
said primary plate coupled to said secondary plate such that said driveshaft is encompassed and confined by said primary plate and said secondary plate coupling.

2. The driveshaft containment apparatus of claim 1, wherein said primary plate and said secondary plate couple to form a circular opening.

3. The driveshaft containment apparatus of claim 1, wherein said secondary plate is horseshoe shaped.

4. The driveshaft containment apparatus of claim 1, wherein said driveshaft containment apparatus further comprises a stiffener plate.

5. The driveshaft containment apparatus of claim 4, wherein said stiffener plate is manufactured onto said primary plate.

6. The driveshaft containment apparatus of claim 1, wherein said driveshaft containment apparatus is manufactured into said vehicle.

7. A method of retrofitting said driveshaft containment apparatus from claim 1 onto said vehicle, comprising:
inserting said primary plate against said crossmember such that said driveshaft is partially confined by said primary plate;
inserting said secondary plate against said primary plate such that said primary plate and said secondary plate encompass and confine said driveshaft; and
applying a plurality of fasteners to said primary plate, said secondary plate and said crossmember such that said primary plate is securely affixed to said crossmember and said secondary plate is securely affixed to said primary plate.

8. A driveshaft containment apparatus assembly kit, for restricting mobility of a driveshaft during a ruptured driveshaft event, said kit comprising:
a primary plate comprising a plurality of fastener holes for securing said primary plate to a secondary plate and securing said primary plate to a crossmember of a vehicle;
said secondary plate comprising a plurality of fastener holes for securing said secondary plate to said primary plate; and
a plurality of fasteners.

9. The kit of claim 8, wherein said primary plate and said secondary plate couple to form a circular opening.

10. The kit of claim 8, wherein said secondary plate is horseshoe shaped.

11. The kit of claim 8, wherein said kit further comprises a stiffener plate.

12. The kit of claim 11, wherein said stiffener plate is manufactured onto said primary plate.

13. The kit of claim 8, wherein said kit further comprises instructions for installation.
